(19) United States
(12) Patent Application Publication
(10) Pub. No.: US 2023/0052608 A1
(43) Pub. Date: Feb. 16, 2023

(54) REMOTE ATTESTATION

(71) Applicant: Hewlett-Packard Development Company, L.P., Spring, TX (US)

(72) Inventors: Gaetan Wattiau, Bristol (GB); Thalia May Laing, Bristol (GB); Joshua Serratelli Schiffman, Washington, DC (US)

(21) Appl. No.: 17/758,594

(22) PCT Filed: Jan. 24, 2020
(86) PCT No.: PCT/US2020/014913

§ 371 Date: Jul. 11, 2022

(51) Int. Cl. G06F 21/57; H04L 9/32

(52) U.S. Cl. CPC G06F 21/577; H04L 9/3247; G06F 2221/034

(57) ABSTRACT

According to aspects of the present disclosure, there is provided methods and devices for verifying integrity of a remote device, including a method comprising generating a first nonce value, transmitting the first nonce value, receiving a message from the remote device, the message comprising measurements of a configuration of the remote device and a cryptographic signature based on a private key of a public-private key pair of the remote device and a second nonce value, determining that the second nonce value was generated based on the first nonce value, and verifying the cryptographic signature based on the second nonce value and a public key of the public-private key pair of the remote device.

### BACKGROUND

In some Internet of Things (IoT) and edge computing environments, numerous devices interoperate to perform various operations, such as manufacturing, data collection, and workflow processing. In such settings, it is desirable to remotely appraise the integrity of these devices to ensure they will perform their tasks correctly.

One method of integrity verification is the use of remote attestation protocols, which request evidence of a running system's configuration linked to a device identity.

### BRIEF INTRODUCTION OF THE DRAWINGS

Various features of the present disclosure will be apparent from the detailed description which follows, taken in conjunction with the accompanying drawings, which together illustrate features of the present disclosure, and wherein:

FIG. 1 illustrates a networked system according to an example of the disclosure;

FIG. 2 shows a method of group attestation according to an example of the disclosure;

FIG. 3 illustrates another method of group attestation according to an example of the disclosure;

FIG. 4 illustrates another method of group attestation according to an example of the disclosure;

FIG. 5 shows a method performed by a verifier device according to an example of the disclosure;

FIG. 6 shows a method performed by an accumulator manager according to an example of the disclosure; and

FIG. 7 is a schematic block diagram of a computer system according to an example of the disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Remote verification of a device's integrity is useful for understanding whether a remote device will behave as expected. Trusted computing hardware may enable a protocol, called remote attestation, for allowing a device to “attest” to its software configuration. Such trusted computing hardware may provide the capabilities for reliably and verifiably presenting evidence to be used to establish trust in the device.

Remote attestation is a mechanism to allow a remote device to determine over a network and without direct access to an attestor device whether the attestor device can be trusted to operate according to certain desired parameters. For example, a publisher may use remote attestation to identify unauthorized changes to software executing on the device, for example to circumvent licensing or copyright protection measures incorporated into the software. The determination may be based on integrity measurements of software components as they are loaded as software instances on the attestor.

The attestation itself may take the form of a signed statement, or “Quote.” This is a set of configuration data and a value for freshness signed by a key tied to the platform's identity and a mechanism trusted for producing the values. As a result, protocols that use this structure may follow a challenge-response pattern. For example, a verifier sends the attestor a randomly generated value, called a nonce. The attestor then takes its measurements of the configuration and returns to the verifier its measurements and a signature on both the measurements and the received nonce. If the nonce is fresh and the measurements are signed by the expected device, then the verifier can make a trust decision based on the contents of the measurements.

Attestation techniques may be applied to settings where there are multiple, lightweight devices (for example, in a factory environment or an IoT setting). These devices may have limited computational and memory capabilities, which can lead to scalability issues.

An attestation protocol may be performed between two parties, an attestor device and a verifier device to allow the verifier device to verify one or more aspects of operation of the attestor device. An example attestation protocol may include the verifying device generating a random number, or nonce, and providing the nonce to the attestor device as part of a request to provide relevant measurements of the operation of the attestor device.

In response to receiving the nonce, the attestor device collects the relevant integrity measurements from its system and generates a digital signature based on both the measurement values and the received nonce. The digital signature may be produced using an asymmetric cryptographic scheme based on a private signing key of a public-private cryptographic key pair associated with the attestor device. The attestor then sends the measurements and the signature to the verifier device.

The verifier device is then able to authenticate the origin of the received measurements using the public key of the public-private key pair associated with the attestor device and the signature. Furthermore, freshness of the measurements is assured by checking that the nonce provided by the verifier device was used to generate the signature. The verifier can then make a trust decision based on the authenticated measurements.

The above described attestation protocol can be considered to comprise the following procedure, with the verifier V, the attestor P, and skₚ/pkₚ, the asymmetric secret and public key pair of P trusted by V:
1. V generates nonce, a random challenge.
2. V sends nonce to P.
3. P generates sig:=Sigₛₖₚ(Hash(nonce∥measurements)).
4. P sends sig and to V.
5. V verifies sig with pkₚ and makes a trust decision for measurements.

Attestation protocols may leverage a hardware root of trust (RoT) to record and authenticate the attested properties. In particular, a hardware security module, such as a trusted platform module (TPM), may be provided at the attestor device to measure aspects of the attestor device operation and generate the signature.

Attestation protocols that operate in line with the above description provide a simple and effective mechanism for remote attestation between one attestor and one verifier. However, this approach may not scale well as the number of verifier devices rises, as each verifier device would provide a nonce value to be used to generate a signature value for the measurements that is unique to that verifier device. Thus, each request from a verifier device results in a separate iteration of the above described attestation protocol.

Each run of an attestation protocol consumes resources, such as power or CPU cycles. Furthermore, hardware security modules such as provided by a TPM or a smart card may often be provided with limited processing capabilities and therefore executing multiple iterations of the attestation protocol may take significant time. Thus, for a lightweight device wishing to attest its operation to multiple different verifiers, participating in multiple attestation protocols may not be practical, given the computational complexity, bandwidth and power requirements involved.

One approach to provide an efficient method of providing attestation measurements to multiple verifiers is to use a trusted agent on the attestor to communicate the requested measurements over a trusted and authenticated channel with the verifiers. However, generating the trusted channel may itself be based on the verifiers determining whether to trust the trusted agent through operation of an attestation protocol as described above.

Certain examples described herein provide methods and devices to allow multiple verifiers to simultaneously appraise a single attestor device in a scalable fashion. This is achieved through use of a group nonce value generated from inputs by each of the verifiers taking part in an attestation protocol that keeps the complexity for the attestor down to that of an attestation protocol with a single verifier.

Considering a scenario in which n verifiers wish to appraise a single device through remote attestation. As discussed above, having the device participate in n runs of the attestation protocol, once with each verifier (O(n) complexity on the attestor), may be impractical for very large n for example a web server responding to a large number of client requests, and/or for lightweight devices, such as for example an IoT device in an edge compute environment. The energy expended to receive n nonces, to compute n signatures and then send n copies of the integrity measurements and all signatures will incur timing delays and constant energy consumption. Moreover, these protocols may rely on a hardware secure key management solution, which may be performance limited due to cost concerns.

Assuming a set of n verifiers V₁, . . . , V₇who all want to appraise a single, lightweight device (the attestor) P, and assuming the verifiers have a (signature verification) public key for the device P. When appraising the device, the verifiers each want to know two things:
1. That the measurements they will receive were generated and sent by P.
2. That the measurements have been recorded recently and have not been replayed.

The verifiers are given assurance that the measurements were generated by P by the use of a signature (which provides authenticity on the measurements) and by knowledge the signing key on the attestor device will only be used to sign measurements generated by the device. While freshness of the measurements may be determined by using a fresh nonce: the verifier sends a nonce, which the device signs along with the measurements, to show the signature and measurements were generated recently and not replayed.

Now, naively, to attest to all n verifiers, the device could participate in n attestation protocols with each verifier and each verifier would then be satisfied. However, it may be impractical for the device to do this due to resource constraints. Instead, according to examples of the disclosure, a method is provided for the attestor device to participate in one attestation protocol, whilst satisfying each verifier simultaneously.

Each verifier wants to individually verify the freshness of the received measurements to avoid replay attacks, and they each do this by inserting their own nonce into the protocol. If the nonce used to generate the signature were to be generated by a different verifier, other verifiers may not trust that the nonce was recently randomly generated. For example, a malicious verifier in charge of generating nonces on behalf of the group of n verifiers may corrupt the device and then send old nonces, replaying past measurements and signatures.

To address this, a single nonce is generated for the attestor device to sign, which allows all verifiers to be satisfied that their input is included in the single nonce. The single, or group nonce, is generated collaboratively by the verifiers such that:
Any verifier can verify the nonce attested to is fresh. They do this by verifying their freshly generated nonce was included in the computation of the group nonce.
The collaboratively generated group nonce is unique.

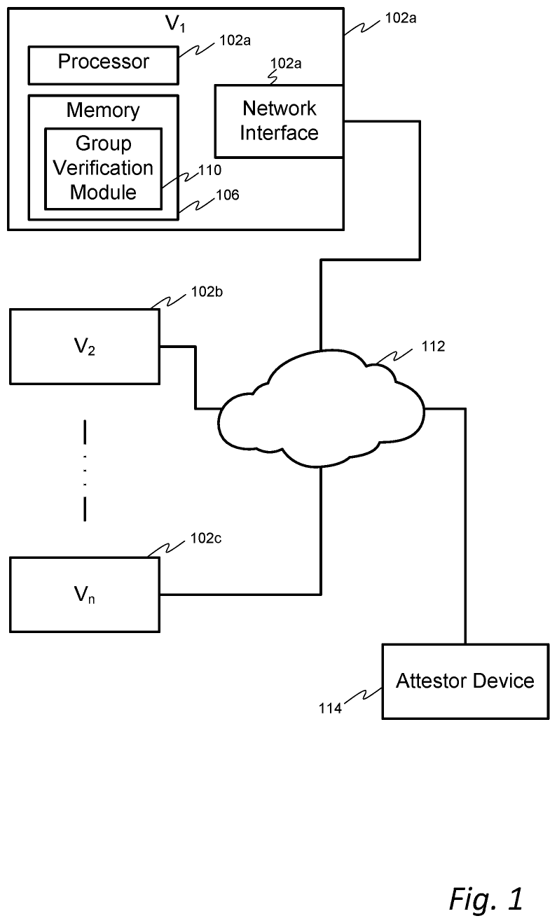

FIG. 1 illustrates a networked system according to an example of the disclosure. The system includes verifier devices V₁ 102a, V₂ 102b, and Vₙ 102n, and an attestor device 114 coupled through network 112. First verifier device, V₁, 102a comprises a processor 104, a memory 106 coupled to the processor 104 and a network interface 108 to allow communication over network 112. Memory 106 stores a group verification module 110 comprising instructions to be executed by the processor to implement a group attestation protocol based on the generation of a group nonce values. Second verifier device V₂ 102b and further verifier device Vₙ 102n may be constituted similarly to first verifier device 102a. It will be recognized that while three verifier devices are illustrated, implementations may include two verifier devices, or greater numbers of verifier devices

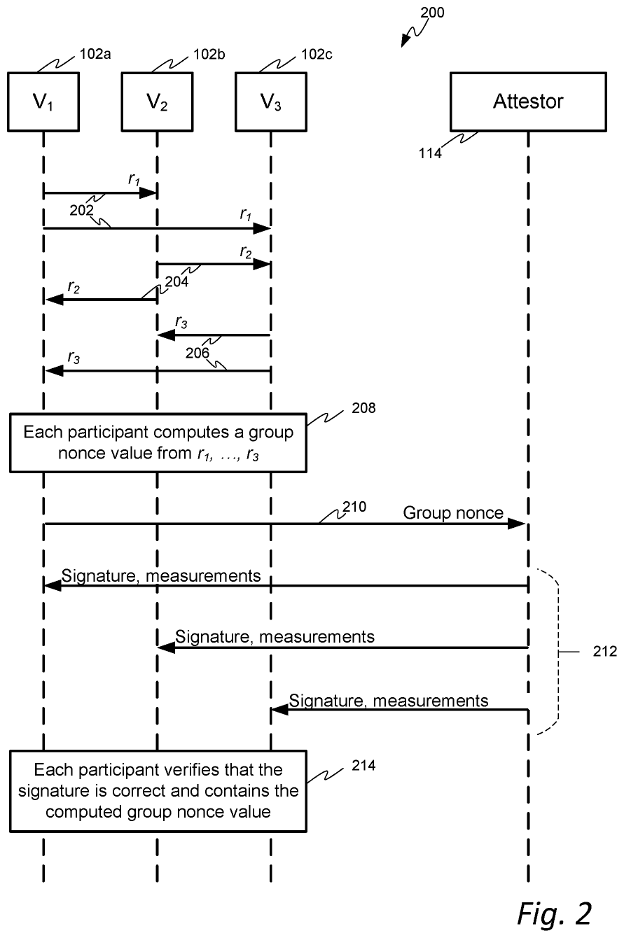

FIG. 2 is a sequence diagram illustrating a method 200 of group attestation using a group nonce to allow three verifier devices V₁ 102a, V₂ 102b and V₃ 102c appraise attestor device 114. According to the method 200 illustrated in FIG. 2, first verifier device 102a generates a random value r₁ and transmits 202 the random value r₁ to V₂ 102b and V₃ 102c. Similarly, second verifier device 102b generates a random value r₂ and transmits 204 the random value r₂ to V₁ 102a and V₃ 102c and third verifier device 102c generates a random value r₃ and transmits 206 the random value r₃ to V₁ 102a and V₂ 102b. Following this exchange, each verifier has knowledge of the random values selected by each of the verifier devices participating in the group attestation protocol.

Each verifier computes 208 the same group nonce value by applying a predetermined deterministic function to the random values r₁, r₂, and r₃. This could be any deterministic function dependent on the random values received: nonce=ƒ(r₁, . . . , rₙ). For example, nonce:=Hash(r₁∥ . . . ∥rₙ) or nonce:=KDF(r₁∥ . . . ∥rₙ). The first verifier device 102a then transmits the group nonce 210 to the attestor device 114, for example as part of an attestation protocol request. In some examples, the group nonce may be transmitted by any number of verifier devices. Alternatively, a third party may be responsible for computing the group nonce dependent on the random nonce values provided by the verifier devices.

In response to the group nonce, the attestor device 114 generates a cryptographic signature for measurements as discussed above using the group nonce. The measurements and signature are then transmitted 212 to each of the verifier devices. Each verifier device is then able to verify 214 the measurements by verifying that the signature has been generated using the expected private key and using the group nonce value that was calculated by the verifier device.

Thus, the attestor 114 is able to generate a single set of measurements and a single signature value that each of the n verifiers are able to determine to be fresh using the group nonce value.

The method 200 illustrated in FIG. 2 can be considered to comprise 7 stages:
1. V₁, . . . , Vₙ each generate a random value r₁, . . . rₙ.
2. Each verifier broadcasts their random value:
   ∀i∈{1, . . . , n} and ∀j∈1, . . . , n, j≠i, Vᵢ sends rᵢ to Vⱼ.
   Now, each verifier has the values r₁, . . . , rₙ.
3. Each verifier computes the same deterministic transformation on r₁, . . . , rₙ.
4. The nonce is sent to P.
5. P generates sig:=Sigₛₖₚ(Hash(nonce∥measurements)).
6. P sends sig and measurements to V₁, . . . , Vₙ.
7. V₁, . . . , Vₙ verify sig with pkₚ and verify that nonce is the same. Each verifier can then make a trust decision based on measurements.

However, depending on the predetermined deterministic function ƒ (defined in Step 3), a dishonest verifier device could compute their nonce based on the other verifiers' random values in such a way as to compromise the uniqueness of the generated nonce. One option to address this issue is to select a collision resistant function, such as a cryptographic hash function or a key derivation function (KDF), to be used as the predetermined deterministic function ƒ.

A further approach to limit the ability of a dishonest verifier device to compromise the generation of the group nonce is for each verifier to transmit a commitment value Cᵣ prior to broadcasting the random values r. The commitment value allows other verifier devices to cryptographically verify that the transmitting device has not changed its random value r after receiving the random values transmitted by other verifier devices.

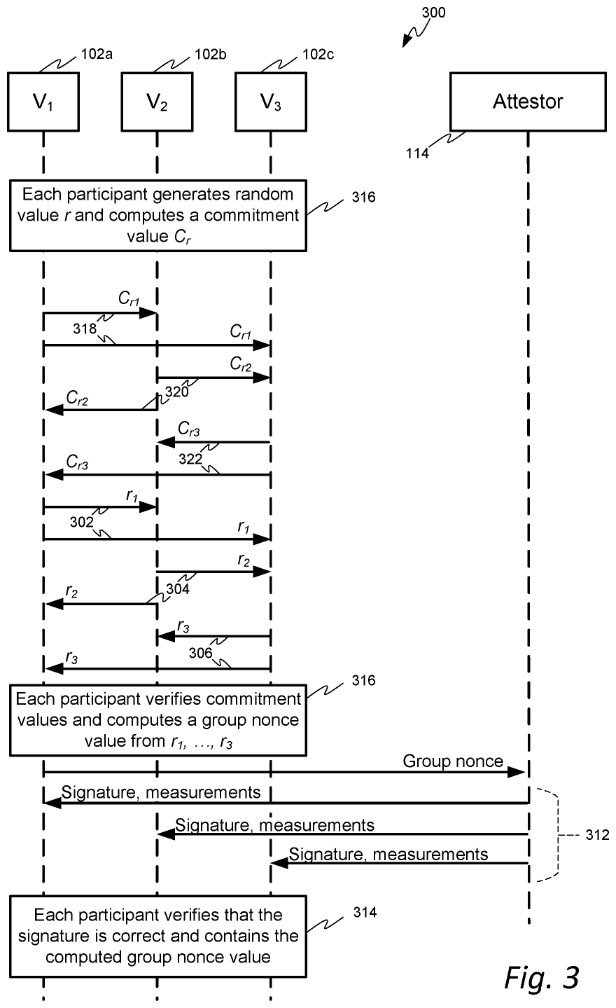

FIG. 3 is a sequence diagram illustrating a method 300 of group attestation similar to the method 200 illustrated in FIG. 2 and further including the use of commitment values Cᵣ to protect against a compromised or dishonest verifier device. According to the method 300 illustrated in FIG. 3, each verifier device begins by generating 316 a random values rₙ and also a commitment value Cᵣₙ that can be used to cryptographically validate the random number rₙ but does not provide information that would allow another entity to calculate the random number rₙ. For example, the commitment value could be generated as a hash of the random value. First verifier device 102a then transmits 318 the commitment value Cᵣ₁ to V₂ 102b and V₃ 102c. Similarly, second verifier device 102b transmits 320 the commitment value Cᵣ₂ to V₁ 102a and V₃ 102c and third verifier device 102c transmits 322 the commitment value Cᵣ₃ to V₁ 102a and V₂ 102b.

Once the commitment values have been received by the verifying devices, the method 300 proceeds similar to method 200 with first verifier device 102a transmitting 302 the random value r₁ to V₂ 102b and V₃ 102c, second verifier device 102b transmitting 304 the random value r₂ to V₁ 102a and V₃ 102c and third verifier device 102c transmitting 306 the random value r₃ to V₁ 102a and V₂ 102b. Following this exchange, each verifier has knowledge of the random values and commitment values generated by each of the other verifier devices participating in the group attestation protocol.

Each verifier device validates each of the received random values based on the corresponding commitment value and then computes 308 the same group nonce value by applying a predetermined deterministic function to the random values r₁, r₂, and r₃. This could be any deterministic function dependent on the random values received: nonce=ƒ(r₁, . . . , rₙ). For example, nonce:=Hash(r₁∥ . . . ∥rₙ), or nonce:=KDF(r₁∥ . . . ∥rₙ). The first verifier device 102a then transmits 310 the group nonce to the attestor device 114, for example as part of an attestation protocol request. In some examples, the group nonce may be transmitted by any number of verifier devices. Alternatively, a third party may be responsible for computing the group nonce dependent on the random nonce values provided by the verifier devices.

In response to the group nonce, the attestor device 114 generates a cryptographic signature for measurements as discussed above using the group nonce. The measurements and signature are then transmitted 312 to each of the verifier devices. Each verifier device is then able to verify 314 the measurements by verifying that the signature has been generated using the expected private key and using the group nonce value that was calculated by the verifier device.

While the methods of FIGS. 2 and 3 provide a computationally efficient (i.e. computation is evenly distributed) method to allow multiple verifier devices to appraise a single attestor device, the broadcasting of the random values, or random values and commitment values, by each of the verifier devices may introduce significant communication overhead.

According to an example, a cryptographic accumulator may be used to generate the group nonce value from the random values generated by the verifier devices.

Cryptographic accumulators represent multiple values (called members). Witness values can be computed by an accumulator holder as a proof that a value is a member of the accumulator. Dynamic accumulators can be based on RSA (e.g. Camenisch-Lysyanskaya accumulator [3]), hash constructions (e.g. Strong accumulators from Collision-Resistant Hashing [4], Merkle trees . . . ), etc. Some schemes rely on trust in the accumulator holder, while others do not. Examples may be implemented using either type of scheme depending on the requirements of the environment and scenario.

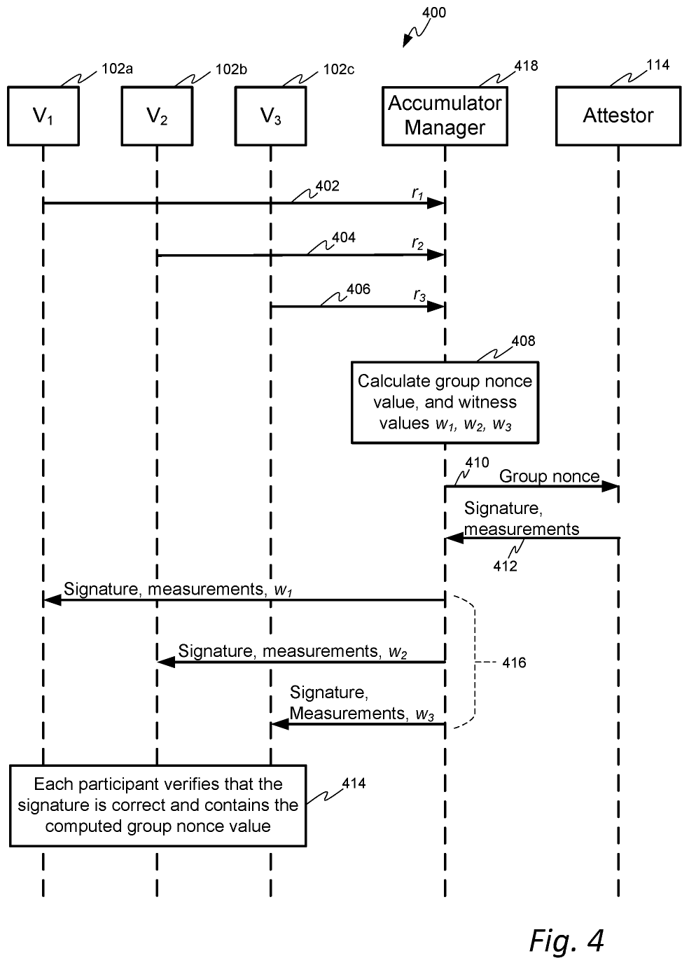

FIG. 4 is a sequence diagram illustrating a method 400 of group attestation using a cryptographic accumulator to generate a group nonce value. According to the method 400 illustrated in FIG. 4, first verifier device 102a generates a random value r₁ and transmits 402 the random value r₁ to an accumulator manager 418. Similarly, second verifier device 102b generates a random value r₂ and transmits 204 the random value r₂ to the accumulator manager 418 and third verifier device 102c generates a random value r₃ and transmits 206 the random value r₃ to the accumulator manager 418.

The accumulator manager 418 updates a cryptographic accumulator value based on each of the received random values and calculates a witness value wₙ corresponding to each random value. The final value of the cryptographic accumulator then forms a group nonce value to be used in an attestation protocol exchange with an attestor device 114.

The accumulator manager 418 then transmits 410 the group nonce to the attestor device 114, for example as part of an attestation protocol request. In response to the group nonce, the attestor device 114 generates a cryptographic signature for measurements as discussed above using the group nonce. The measurements and signature are then transmitted 412 to accumulator manager 418. Accumulator manager 418 then sends 416 the measurements and signature to each of the verifier devices 102a, 102b, 102c. Accumulator manager 418 further provides a witness value to each verifier device corresponding to the random number value provide by that verifier.

Each verifier device is then able to verify 414 the measurements by verifying that the signature has been generated using the expected private key and using the witness value to validate that the group nonce value was generated based on the random value provided by the verifier device.

The method 400 of FIG. 4 does not rely on the presence of a broadcast channel between the verifier devices. Instead, a new agent is introduced, the accumulator manager M 418. Accumulator manager 418 is a device that will interface between V₁, . . . , Vₙ and attestor device P. In some examples the function of the accumulator manager 418 may be provided by one of the verifier devices 102a, 102b, 102c, an external party, or may the attestor device 114. Depending on the accumulator scheme chosen to generate the cryptographic accumulator value, M may not be a trusted entity.

The attestation protocol of method 400 illustrated in FIG. 4 can be described as follows:
1. M sets up an accumulator, acc.
2. V₁, . . . , Vₙ each generate a random value (according to the corresponding dynamic accumulator scheme) r₁, . . . , rₙ.
3. Each verifier sends their random value to M:
∀i∈{1, . . . , n}, Vᵢ sends r₁ to M.
4. M updates acc with each value r₁, . . . , rₙ.
5. M sends acc to P. And generates witness value w₁, . . . , wₙ for r₁, . . . , rₙ.
6. P generates sig:=Sigₛₖₚ(Hash(acc∥measurements)).
7. P sends sig to V₁, . . . , Vₙ.
8. ∀i∈{1, . . . , n}, M sends acc and wᵢ to Vᵢ.
9. ∀i∈{1, . . . , n}, Vᵢ verifies sig with pkₚ, verifies that acc was used in sig and verifies the witness wᵢ (rᵢ belongs to acc). Vᵢ can now make a trust decision based on measurements.

To further illustrate the method 400 of FIG. 4, an example accumulator scheme is described. According to the example, each member of accumulator acc, that is the random values r₁, . . . , rₙ provided by verifier devices, is a random prime number e. An accumulator containing e₁, . . . , eₙ is defined as the product acc:=e₁· . . . ·eₙ (i.e. to update acc with eⱼ, multiply acc with eⱼ:acc=acc·eⱼ).

While factorising a product of prime numbers is computationally difficult, determining that a prime number is a factor of the product may be achieved relatively easily. Therefore, the witness value wᵢ of eᵢ for acc is acc and to verify that eᵢ belongs to acc, we verify that eᵢ divides acc.

Using this example accumulator scheme, the method of FIG. 4 may be implemented by accumulator manager 418 initializing an accumulator, acc=1. Verifier devices, V₁, . . . , Vₙ each generate a random prime numer e₁, . . . , eₙ and transmit their random number to the accumulator manager 418 M (∀i∈{1, . . . , n}, Vᵢ sends e₁ to M). The accumulator manager 418 updates acc with each value e₁, . . . , eₙ, transmits the final acc value to attestor device 114, and generates witness value w₁= . . . =wₙ=acc.

Attestor device 114 generates sig :=Sigₛₖₚ(Hash(acc∥(measurements)) and transmits sig to verifier devices V₁, . . . , Vₙ. The sig may be transmitted via the accumulator manager 418 or direct to the verifier devices. Accumulator manager 418 further provides the accumulator value acc to the verifier devices.

Each verifier device, V₁, . . . , Vₙ, verifies the received sig with a public key corresponding to attestor device 114, pkₚ, and further verifies that acc was used in sig and that the random prime number, eᵢ, generated by the verifier device divides acc. Following successful verification of the signature, the verifier device 102a is then able to determine whether to trust the attestor device 114 based on the measurements.

The use of a cryptographic accumulator to generate the group nonce value allows a significant proportion of the computation to implement the method 400 to be performed by an untrusted third party. For example, a more computationally powerful device such as a cloud or edge server could be used. This may be particularly advantageous when implementing a group attestation protocol for large numbers of lightweight devices such as IoT devices or edge devices, for example a printing device or 3D printer.

The disclosed methods provide an attestation protocol that allows a single attestor device to provide signed measurements to multiple verifier devices with the same computational requirements on the attestor device as for a single verifier device, i.e. O(1) (instead of O(n)) computational complexity on the attestor device as a function of the number of verifiers n.

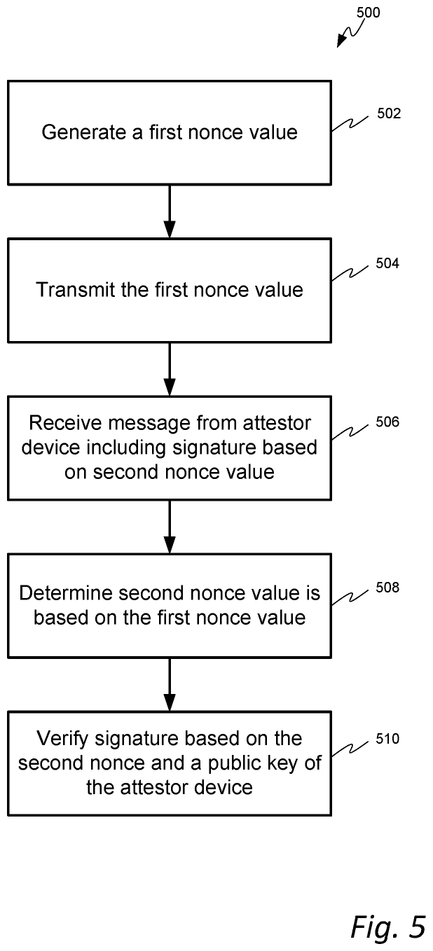

FIG. 5 shows a method 500 according to an example of the disclosure to allow a verifier device 102a to take part in a group attestation protocol as described above. According to the method 500 of FIG. 5, the verifier device 102a generates 502 a first nonce value, such as a random number, and transmits 504 the first nonce value, for example broadcasting to other verifier devices or transmitting to an accumulator manager.

The verifier device 102a then receives 506 a message from a remote, attestor, device including a signature based on a second nonce vale. The message may further comprise measurements of the internal state of the attestor device. The verifier device 102a determines 508 whether the second nonce value was generated based on the first nonce value provided by the verifier device, for example, based on a witness value. If the second nonce value is determined to have been generated based on the first nonce value, the verifier device then verifies 510 the signature based on the second nonce and on a public key associated with the attestor device.

The verifier device may then determine whether the attestor device is to be trusted based on the successful verification of the cryptographic signature and the contents of the received message.

In examples, the method 500 may comprise the verifier device 102a broadcasting the first nonce value to a plurality of verifying devices, receiving a plurality of third nonce values from the plurality of verifying devices, generating a fourth nonce value based on the plurality of third nonce values and the first nonce value and determining that the second nonce value was generated based on the first nonce value by determining that the second nonce value and the fourth nonce value are the same.

In examples, the method 500 may further comprise transmitting a request for measurements of the configuration of the remote, attestor, device to the remote device including the fourth nonce value. Generating the fourth nonce value from the plurality of third nonce values and the first nonce value may comprise using a collision resistant cryptographic function.

In examples, the method 500 may further comprise generating a first commitment value based on the first nonce value, broadcasting the first commitment value to the plurality of verifying devices; and receiving a plurality of second commitment values from the plurality of verifying devices, each second commitment value based on one of the third nonce values; subsequent to receiving the commitment values, broadcasting the first nonce value to a plurality of verifying devices, and receiving a plurality of third nonce values from the plurality of verifying devices, and the method further comprising verifying the second commitment values based on the received third nonce values.

In examples, the method 500 may further comprise transmitting the first nonce value to an accumulator manager and receiving the message from the remote device via the accumulator manager. The method 500 may further comprise receiving the second nonce value from the accumulator manager, receiving a witness value from the accumulator manager, and wherein determining that the second nonce value was generated based on the first nonce value further comprises verifying that the second nonce was generated based on the first nonce based on the witness value.

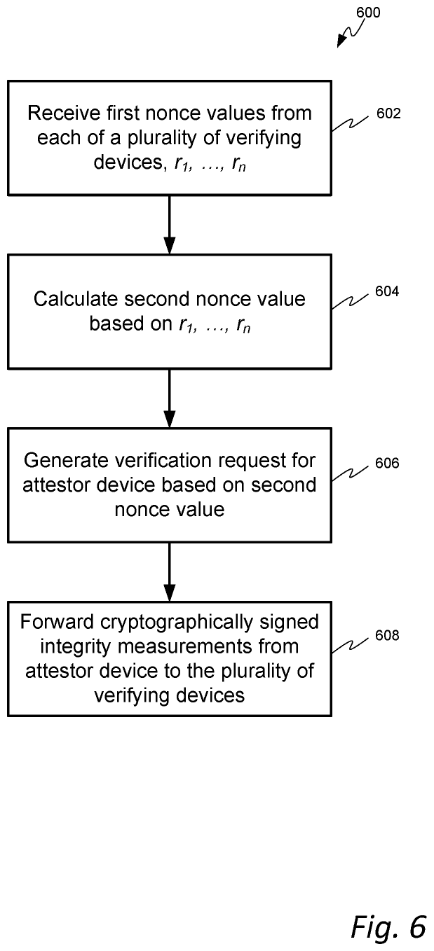

FIG. 6 shows a method 600 according to an example of the disclosure of the operation of an accumulator manager 418 in a group attestation protocol as described above. According to the method 600 of FIG. 6, the accumulator manager receives 602 first nonce values r₁, . . . , rₙ from each of a plurality of verifier devices 102a, 102b, 102c. The received first nonce values r₁, . . . , rₙ are used as members of a cryptographic accumulator to calculate 604 a second nonce value acc. A verification request to an attestor device to perform an attestation protocol is then generated 606, including the second nonce value acc, and sent to attestor device 114.

In response to the verification request, the accumulator manager 418 receives cryptographically signed integrity measurements from the attestor device 114 and forwards 608 the measurement results and associated signature to the verifier devices 102a, 102b, 102c.

In some examples, the accumulator manager functionality may be performed one of the verifier devices 102a, 102b, 102c, or by attestor device 114. The method may further comprise, for each of the plurality of verifier devices 102a, 102b, 102c, generating a witness value based on the second nonce value and the first nonce value received from that verifier device, and providing the second nonce value and the witness value to the verifier device.

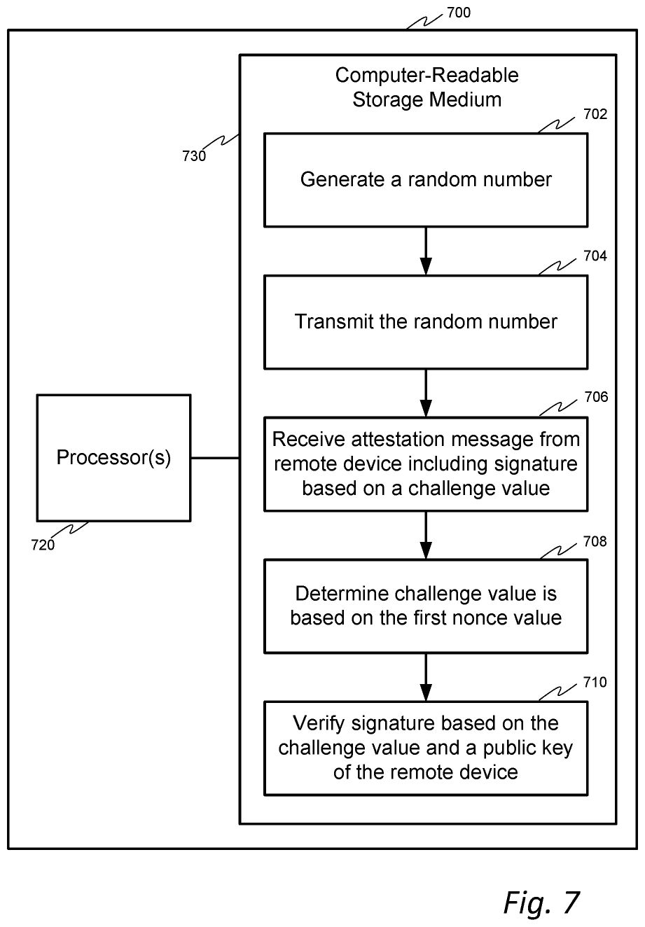

Certain methods and systems as described herein may be implemented by a processor that processes program code that is retrieved from a non-transitory storage medium. FIG. 7 shows an example 700 of a device comprising a computer-readable storage medium 730 coupled to at least one processor 720.

Processors suitable for the execution of computer program code include, by way of example, both general and special purpose microprocessors, application specific integrated circuits (ASIC) or field programmable gate arrays (FPGA) operable to retrieve and act on instructions and/or data from the computer readable storage medium 730.

The computer-readable media 730 can be any media that can contain, store, or maintain programs and data for use by or in connection with an instruction execution system. Computer-readable media can comprise any one of many physical media such as, for example, electronic, magnetic, optical, electromagnetic, or semiconductor media. More specific examples of suitable machine-readable media include, but are not limited to, a hard drive, a random-access memory (RAM), a read-only memory (ROM), an erasable programmable read-only memory, or a portable disc.

In FIG. 7, the computer-readable storage medium comprises program code to when executed on a computing device: generate a first nonce value, comprising a random number; transmitting 704 the first nonce value; receiving 706 an attestation message from a remote device, or attestor device, 114 the attestation message comprising integrity measurements of the remote device and a cryptographic signature based on a private key of a public-private key pair of the remote device and a challenge value; determine 708 that the challenge value was generated based on the random number; and verify 708 the cryptographic signature based on the challenge value and a public key of the public-private key pair of the remote device 114.

In response to determining that the challenge value was generated based on the random number and successfully verifying the cryptographic signature, the code may further cause the computing device to determine whether the remote device can be trusted based on the integrity measurements.

In other examples, computer-readable storage medium 730 may comprise program code to perform any of the methods illustrated in FIGS. 2 to 6 and discussed above.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants which fall within the scope of the claims.

1. A method of verifying integrity of a remote device, the method comprising:
generating a first nonce value;
transmitting the first nonce value;
receiving a message from the remote device, the message comprising measurements of a configuration of the remote device and a cryptographic signature based on a private key of a public-private key pair of the remote device and a second nonce value;
determining that the second nonce value was generated based on the first nonce value; and
verifying the cryptographic signature based on the second nonce value and a public key of the public-private key pair of the remote device.

2. The method of claim 1, further comprising determining whether the remote device can be trusted based on the measurements and successfully verifying the cryptographic signature.

3. The method of claim 1, wherein transmitting the first nonce value further comprises broadcasting the first nonce value to a plurality of verifying devices, the method further comprising:
receiving a plurality of third nonce values from the plurality of verifying devices;
generating a fourth nonce value based on the plurality of third nonce values and the first nonce value; and
wherein determining the second nonce value was generated based on the first nonce value comprises determining that the second nonce value and the fourth nonce value are the same.

4. The method of claim 3, further comprising transmitting a request for measurements of the configuration of the remote device to the remote device, the request comprising the fourth nonce value.

5. The method of claim 3, wherein generating the fourth nonce value comprises calculating the fourth nonce value from the plurality of third nonce values and the first nonce value using a collision resistant cryptographic function.

6. The method of claim 3, further comprising:
generating a first commitment value based on the first nonce value;
prior to broadcasting the first nonce value:
broadcasting the first commitment value to the plurality of verifying devices; and
receiving a plurality of second commitment values from the plurality of verifying devices, each second commitment value based on one of the third nonce values; and
the method further comprising verifying the second commitment values based on the received third nonce values.

7. The method of claim 1, wherein transmitting the first nonce value comprises transmitting the first nonce value to an accumulator manager and wherein receiving the message from the remote device comprises receiving the message from the remote device via the accumulator manager.

8. The method of claim 7, further comprising:
receiving the second nonce value from the accumulator manager;
receiving a witness value from the accumulator manager; and
wherein determining that the second nonce value was generated based on the first nonce value further comprises verifying that the second nonce was generated based on the first nonce based on the witness value.

9. A method of generating an integrity challenge, the method comprising:
for each of a plurality of verifying devices, receiving a first nonce value;
generating a second nonce value based on the first nonce values;
generating a request for integrity measurements from an attestor device, the request comprising the second nonce value; and
forwarding cryptographically signed integrity measurements provided by the attestor device to the plurality of verifying devices.

10. The method of claim 9, wherein the method is performed by the attestor device.

11. The method of claim 9, further comprising:
for each of the plurality of verifying devices:
generating a witness value based on the second nonce value and the first nonce value received from that verifying device; and
providing the second nonce value and the witness value to the verifying device.

12. A non-transitory computer readable medium comprising instructions that when executed on a computing device, cause the computing device to:
generate a random number;
transmit the random number;
receive an attestation message from a remote device, the attestation message comprising integrity measurements of the remote device and a cryptographic signature based on a private key of a public-private key pair of the remote device and a challenge value;
verify the cryptographic signature based on the challenge value and a public key of the public-private key pair of the remote device;
determine that the challenge value was generated based on the random number; and
in response to determining that the challenge value was generated based on the random number and successfully verifying the cryptographic signature, determine whether the remote device can be trusted based on the integrity measurements.

13. The non-transitory machine readable medium of claim 12, wherein the instructions are further to, when executed on the computing device, cause the computing device to:
broadcast the random number to a plurality of verifying devices;
for each of the plurality of verifying devices, receive a respective second random number from that verifying device;
calculate a second challenge value using a deterministic function based on the random number and the received second random numbers; and
wherein the determination that the challenge value was generated based on the random number comprises determining that the challenge value is equal to the second challenge value.

14. The non-transitory machine readable medium of claim 13, wherein the instructions are further to, when executed on the computing device, cause the computing device to:
generate a first commitment value based on the random number;
broadcast the first commitment value to the plurality of verifying devices prior to broadcasting the first random number;
receive a plurality of second commitment values from the plurality of verifying devices, each second commitment value based on the respective second random number, prior to transmitting the random number; and
determine for each verifying device that the second commitment value received from that verifying device is based on the second random number.

15. The non-transitory machine readable medium of claim 12, wherein the random number is transmitted to an accumulator manager and wherein the instructions are further to, when executed on the computing device, cause the computing device to:
receive the challenge value from the accumulator manager;
receive a witness value from the accumulator manager, the witness value based on the random number and the challenge value; and
wherein the determination that the challenge value was generated based on the random number is further based on the received witness value.
